(19) United States
(12) Patent Application Publication
(10) Pub. No.: US 2019/0360367 A1
(43) Pub. Date: Nov. 28, 2019

(54) ELECTROMAGNETIC ACTUATOR AND METHODS OF OPERATION THEREOF

(71) Applicant: Camcon Auto Limited, Cambridge (GB)

(72) Inventors: Roger Stone, Brighton (GB); Richard Tyrrell, Pulborough (GB); Owen Evans, Brighton (GB); David Kelly, Warwick (GB)

(21) Appl. No.: 16/332,728

(22) PCT Filed: Oct. 5, 2017
(86) PCT No.: PCT/GB2017/053016

§ 371 Date: Mar. 12, 2019

(30) Foreign Application Priority Data
Oct. 6, 2016 (GB) 1616982.3

(51) Int. Cl. F01L 9/04; H02K 7/075; F01L 1/18

(52) U.S. Cl. CPC F01L 9/04; H02K 7/075; F01L 2009/0442; F01L 2009/0411; F01L 2105/00; F01L 1/185

(57) ABSTRACT

A rotary electromagnetic actuator includes a biasing assembly for applying a torque to its rotor. Such an actuator may be used to operate a poppet valve of an internal combustion engine. The biasing assembly is switchable between (a) a first configuration in which the biasing assembly exerts a torque on the rotor over at least part of the range of rotation of the rotor, wherein the torque exerted varies with the rotational position of the rotor according to a torque profile, and (b) a second configuration in which the biasing assembly exerts substantially no torque on the rotor over the range of the rotor.

### FIELD OF THE INVENTION

The present invention relates to an electromagnetic actuator. More particularly, it relates to a rotary electromagnetic actuator having a rotor which is rotatable relative to a stator and including a biasing assembly for applying a torque to the rotor. Such an actuator may be used to operate a poppet valve of an internal combustion engine for example.

### BACKGROUND TO THE INVENTION

WO2004/097184 describes a rotary electromagnetic actuator which may be used to open and close a valve of an internal combustion engine. In one example, a resilient cantilevered spring arm is in contact with the outer circumference of an eccentric surface which rotates with the rotor. The arm is deformed over part of the rotation of the rotor and thereby stores strain energy which is subsequently used to accelerate the rotation of the rotor.

### SUMMARY OF THE INVENTION

The present invention provides an electromagnetic actuator comprising:
a stator;
a rotor which is rotatable relative to the stator over a range of rotation of the rotor; and
a biasing assembly for applying a torque to the rotor,
wherein the biasing assembly is switchable between:
   (a) a first configuration in which the biasing assembly exerts a torque on the rotor over at least part of the range of rotation of the rotor, wherein the torque exerted varies with the rotational position of the rotor according to a torque profile; and
   (b) a second configuration in which the biasing assembly exerts no or substantially no torque on the rotor over the range of rotation of the rotor.

The inventors realised that in some applications for an electromagnetic actuator including a biasing assembly, it can be beneficial to be able selectively to effectively remove the biasing effect (for practical purposes) or remove it altogether.

For example, in applications where the actuator is used to operate a valve of an internal combustion engine, each cycle of the rotor (which may be a full rotation of the rotor or rotation of the rotor back and forth across its range of rotation) may correspond to a valve event, that is the opening and closing of the associated valve. It may be desirable to modify the operating characteristics of the electromagnetic actuator from one valve event or actuator cycle to the next. With an actuator of the present disclosure, the influence of the biasing assembly can be removed entirely from one or more cycles depending on the operating conditions of the engine.

For example, during high energy valve events (that is when a rapid, high lift event is required), it may be preferable to utilise the full benefit of the biasing assembly and the energy recycling it provides to minimise energy consumption. Conversely, during gentler, slower valve events, it may be preferable to disengage the biasing assembly. This is facilitated by the present invention.

In some embodiments, the range of rotation of the rotor may be a portion of a full rotation, with the rotor being controllable to oscillate back and forth over this portion. Alternatively, the range of rotation of the rotor may be a full rotation, enabling the rotor to rotate continuously in the same direction and/or oscillate between two end points.

In preferred embodiments, kinetic energy of the rotor is converted into potential energy stored in the biasing assembly over part of the rotation of the rotor and then this potential energy is subsequently transferred back to the rotor during another part of the rotation of the rotor in order to accelerate the rotation of the rotor.

The biasing assembly may be implemented mechanically, hydraulically or pneumatically, for example. Preferably, the biasing assembly is a mechanical assembly and comprises a resilient mechanical component. This component may serve to generate a biasing force which is exerted on the rotor by the biasing assembly.

The rotor may be coupled to the biasing assembly such that, as the rotor rotates over at least part of its range of rotation, part of the resilient mechanical component is moved or deflected. The constraining member may act to constrain movement of part of the resilient mechanical component (causing it to deform and exert a torque on the rotor) or provide no constraint (such that the component is not deformed and so does not exert a torque on the rotor). In this way, a constraining member may be operable to control whether a torque is exerted on the rotor by the biasing assembly. The constraining member may contact the resilient mechanical component directly.

In some embodiments, the rotor defines a cam surface and the biasing assembly includes a cam follower in engagement with the cam surface, and the magnitude of the torque exerted on the rotor by the biasing assembly is dependent on the magnitude of the displacement of the cam follower by the cam surface. Preferably, a first part of the resilient mechanical component forms or is coupled to the cam follower and moves in response to movement of the cam follower. In further embodiments, a second part of the resilient mechanical component is more constrained in the first configuration of the biasing assembly than in the second configuration.

It will be appreciated that the resilient mechanical component of the biasing assembly may take various forms, such as a spring or a block of resilient material.

In some implementations, the resilient mechanical component is a leaf spring which is pivotably mounted. In such a configuration, a portion of the spring which is spaced from the pivot is deflected over at least part of the rotation range of the rotor.

The cam follower may be urged towards the resilient mechanical component. The resilient component may in turn be urged towards the constraining member. This is to avoid rattling of parts when the biasing assembly is not exerting a torque on the rotor via the cam follower. Each urging force may be generated by a resilient element such as a spring, for example. Both urging forces may be generated by the same resilient element acting on the cam follower.

In further embodiments, movement of the second part of the resilient mechanical component is constrainable by reducing the distance between an engagement surface of the constraining member and the resilient mechanical component (that is, the distance between the engagement surface and the resilient component when the resilient component is in its undeflected, or minimum deflection position). For example, the constraining member may be a rotatable member which is rotated between its first orientation and its second orientation when the biasing assembly moves between its first configuration and its second configuration, respectively, wherein the engagement surface of the constraining member moves in a direction towards the resilient mechanical component when the rotatable member moves from its first orientation to its second orientation.

The present invention further provides a control mechanism in combination with an actuator as described herein, wherein the control mechanism comprises:
a controller which is moveable between first and second controller positions; and
a coupling between the controller and the biasing assembly,
wherein the coupling is arranged such that when the controller is in the first controller position, the coupling urges the constraining member towards its first orientation.

It may be preferable to have a resilient, urging coupling between the controller and the biasing assembly, rather than a rigid coupling arrangement. In some instances, the constraining member may not be able to move into its first orientation at the time the controller is switched from its second position to its first position (it may be blocked from doing so by the resilient component of the biasing assembly for example). The use of a resilient coupling or a “lost motion” coupling between the controller and the biasing assembly enables the controller to move so that the coupling urges the constraining member towards its first configuration.

Thus, the controller may be able to move from its second controller position to its first controller position even if the constraining member is not initially able to move into its first orientation.

In some embodiments, the coupling comprises a resilient component which enables the controller to move from its second controller position to its first controller position even if the constraining member is not initially able to move into its first orientation.

The coupling may be able to accommodate movement of the controller from its second to its first position even if the constraining member is not initially able to move into its first configuration, and then move the constraining member into its first orientation as and when it becomes able to do so. The coupling may exert a biasing force on the constraining member towards its first orientation.

In some embodiments, the controller may comprise a rotatable controller member which is rotatably mounted and/or the constraining member may be rotatably mounted. In such a configuration, the resilient component may be a torsion spring, for example.

A control mechanism as described herein may be provided in combination with a plurality of actuators as described herein. Such a combination may include a plurality of couplings, with each coupling provided between the controller and the biasing assembly of a respective one of the actuators, wherein each coupling is arranged such that when the controller is in the first controller position, the coupling urges the constraining member of the respective one of the actuators towards its first orientation. In some applications, a set of actuators may not be controlled to operate simultaneously, but instead are actuated out of phase. This may be the case where the actuators are associated with different cylinders of an internal combustion engine for example. Under some operating configurations, actuators for valves of the same cylinder may have a common controller but operate out of phase. In embodiments of the invention, the couplings between the controller and each biasing assembly are able to accommodate this. As each coupling exerts an urging force on each constraining member, they are able to transmit the switching action several biasing assemblies, with each assembly only switching when it is able to do so. For example, switching may only take place when a biasing assembly is exerting no (or minimal) torque on the associated rotor.

The present invention further provides an internal combustion engine including at least one cylinder having at least one valve and an actuator as described herein, wherein the actuator is arranged to actuate the at least one valve. In further embodiments, an engine may include a plurality of cylinders each having at least one valve and a combination of a control mechanism with an actuator as described herein, with each of the actuators arranged to actuate a respective valve.

In some implementations, one controller may be coupled to the biasing assemblies of a plurality of actuators such that a single controller is able to switch a plurality of actuators, with the couplings accommodating out of phase operation of the actuators so that each actuator is only switched when it is able to do so.

In other implementations, each actuator may have its own coupling and controller with each controller being moveable independently of the other controllers. In this way, the biasing assembly of each actuator may be switched by its own corresponding controller independently of the others.

In further embodiments, an engine may include a plurality of cylinders each having at least two valves, with one valve of each cylinder belonging to a first set of valves and a second valve of each set belonging to a second set of valves. Each set of valves may have an associated controller, with couplings provided between the controller and each valve of the respective set, with the controller associated with each set being moveable independently of the other controller. For example, an internal combustion engine may have a pair of inlet valves (or a pair of outlet valves) associated with each cylinder. One valve of each pair may be designated as a primary valve and the other as a secondary valve. The primary valves may form a first set with their own controller and the second secondary valves form a second set, again with their own controller. In some operating modes of the engine, it may be desirable for the primary valves to be operated in a different manner to the secondary valves and this configuration facilitates this. For example, in one mode, the biasing assemblies of the first set may be in their first configuration, whilst the biasing assemblies of the second set may be in their second configuration (or vice versa).

Furthermore, the present invention provides a method of operating an electromagnetic actuator comprising:
a stator;
a rotor which is rotatable relative to the stator over a range of rotation of the rotor; and
a biasing assembly for applying a torque to the rotor,
the method comprising the step of switching the biasing assembly between:
   (a) a first configuration in which the biasing assembly exerts a torque on the rotor over at least part of the range of rotation of the rotor, wherein the torque exerted varies with the rotational position of the rotor according to a torque profile; and
   (b) a second configuration in which the biasing assembly exerts no or substantially no torque on the rotor over the range of rotation of the rotor.

### BRIEF DESCRIPTION OF THE DRAWINGS

Embodiments of the invention will now be described by way of example and with reference to the accompanying schematic drawings, wherein:

FIG. 1 is a perspective front view of a pair of rotary electromagnetic actuators, with one of the actuators embodying the invention;

FIG. 2 is a plan view of part of an internal combustion engine including a set of actuators according to an embodiment of the invention;

FIGS. 3 and 4 are end and side views, respectively of the assembly shown in FIG. 2 with the biasing assemblies of the actuators in their first, activated configuration, with FIG. 3 being a cross-sectional end view along line A-A marked in FIG. 4;

FIGS. 5 and 6 are end and side views, respectively of the assembly shown in FIG. 2 with the biasing assemblies of the actuators in their second, deactivated configuration, with FIG. 5 being a cross-sectional end view along line B-B marked in FIG. 6;

FIG. 7 is a perspective rear view of the pair of actuators shown in FIG. 1;

FIG. 8 is an enlarged perspective view of one end of the assembly shown in FIG. 3;

FIG. 9 is a cross-sectional end view of the assembly shown in FIG. 2 along line C-C;

FIG. 10 is a plan view of part of an internal combustion engine according to another embodiment of the invention; and

FIG. 11 is a perspective end view of part of the assembly shown in FIG. 10.

### DETAILED DESCRIPTION OF THE DRAWINGS

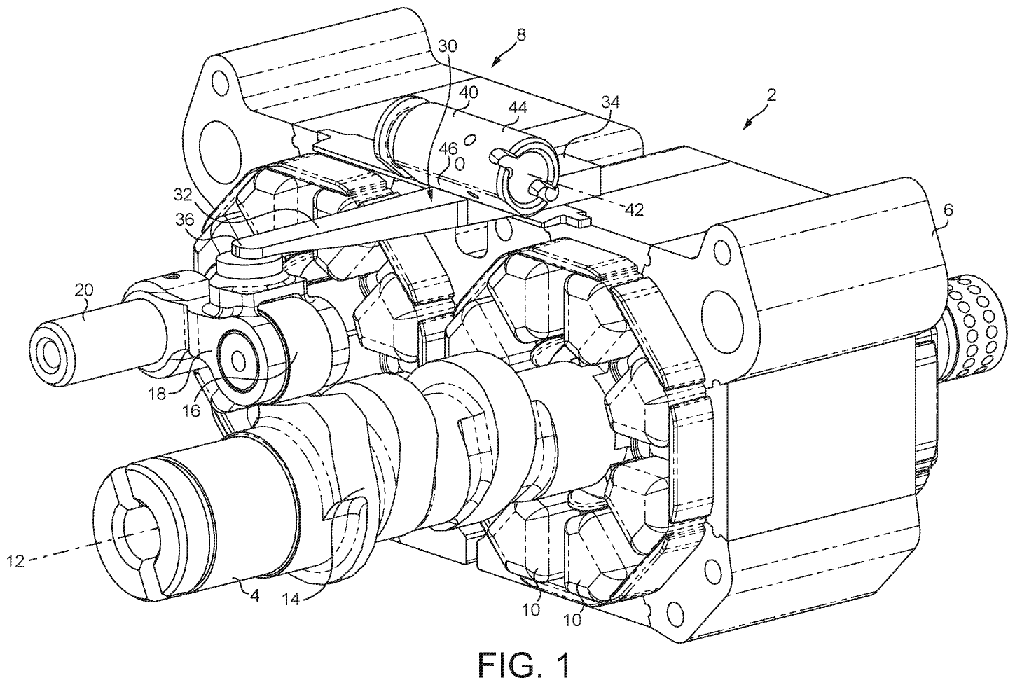

A rotary electromagnetic actuator 2 embodying the invention is shown in FIG. 1. It includes a rotor 4 which is rotatably mounted in a stator 6. In the embodiment shown, the stator 6 is shared with a second actuator 8. The stator includes eight coils 10 which are evenly circumferentially spaced around the rotor, with respect to the rotational axis 12 of the rotor. In operation of the actuator, a magnetically generated torque is exerted on the rotor by selectively energising the stator windings. The rotor of actuator 8 is omitted for clarity in the drawing.

A cam surface 14 is formed on the rotor. A cam follower in the form of a roller 16 is in engagement with the cam surface. The cam follower 16 is rotatably mounted at one end of an arm 18. The other end of the arm is rotatably mounted on a shaft 20. Shaft 20 is supported by a bearing housing for the rotor 4. This bearing housing is omitted for clarity in FIG. 1. The exposed part of the shaft 20 is a press fit into a bore in the bearing housing.

The cam follower 16 is urged into engagement with the cam surface 14 by a biasing assembly 30. This assembly includes a leaf spring 32. The leaf spring is pivotably mounted on the stator 6 at a first end 34. A second, opposite end 36 of the leaf spring bears against the cam follower arm 18, urging it downwardly, towards the cam surface 14. The leaf spring, cam follower and cam surface are arranged such that the biasing assembly can exert a force on the rotor which acts to one side of the rotor axis, rather than towards it, so that it generates a torque around this axis.

Preferred cam surface configurations are disclosed in a co-pending UK patent application filed by the present applicants.

The biasing assembly also includes a constraining member in the form of a locking cylinder 40. The locking cylinder 40 is mounted in use for rotation about its central, longitudinal axis 42, by means not shown in FIG. 1. When the locking cylinder is orientated as shown in FIG. 1, its cylindrical circumferential surface 44 is in engagement with the upper surface of a part of the leaf spring 32 located towards first end 34 and so constrains upward movement of the leaf spring. The circumferential surface of the locking cylinder also includes a flattened, planar portion 46, which extends in a plane parallel to the rotational axis 42 of the locking cylinder and perpendicular to a plane containing that axis.

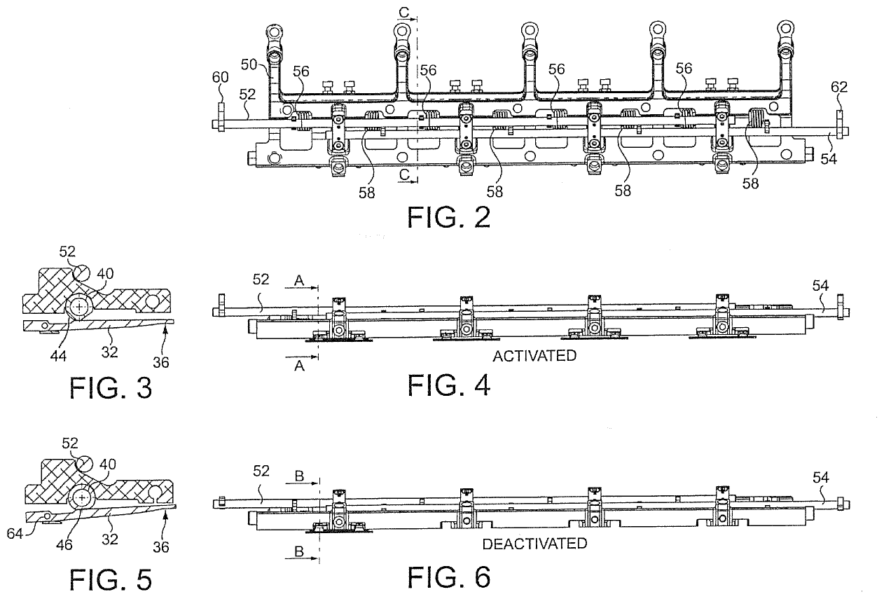

The biasing assembly 30 is switchable between a configuration (as shown in FIG. 1) in which upwards movement of the leaf spring in response to the interaction between the cam surface 14 and cam follower 16 is constrained by the constraining member 40, and a second configuration in which the upwards movement of the leaf spring is unconstrained when its second end 36 is moved in response to the interaction between the cam surface 14 and the cam follower 16. This will be described in further detail with reference to FIGS. 2 to 8.

FIG. 2 shows a plan view of an assembly for fastening to an actuator housing which is in turn fastened to the cylinder head of an internal combustion engine. It comprises a supporting framework 50 which carries two control mechanisms for controlling two sets of biasing assemblies, each biasing assembly being associated with a corresponding rotary actuator.

Each of the control mechanisms comprises a controller in the form of a rotatable shaft 52,54. Each shaft is coupled to a set of four actuators by respective couplings 56 and 58. More particularly, the couplings comprise torsion springs connected between each shaft and a constraining member of each actuator biasing assembly. Each shaft is rotatable by a respective actuator (not shown) which is connected to a respective crank arm 60,62.

FIGS. 3 and 4 show the control mechanisms in their activated configuration and FIGS. 5 and 6 show the control mechanisms in their deactivated configuration.

In the activated configuration, it can be seen in FIG. 3 that the circumferential surface 44 of the locking cylinder 40 is in contact with an upper surface of the leaf spring 32. This corresponds to the orientation shown in FIG. 1. Upwards movement of the leaf spring at the location in contact with the constraining member is blocked by the locking cylinder. Accordingly, when the distal end 36 of the leaf spring is pushed upwards by the cam follower arm 18, the leaf spring is therefore deformed and will exert a resilient biasing force on the arm 18. It will also store energy in the form of mechanical strain energy. This energy will then be transferred back to the rotor as and when the end 36 of the leaf spring is allowed to move downwards, causing the cam follower 16 to exert an accelerating torque on the rotor.

In the deactivated configuration shown in FIGS. 5 and 6, the locking cylinder 40 has been rotated by the associated switching shaft 52. The cylinder has rotated such that its planar face 46 is facing towards the leaf spring. As a result, the surface of the locking cylinder adjacent to the leaf spring is spaced from the leaf spring when the leaf spring is in its non-deflected position. When the distal end 36 of the leaf spring is then displaced upwards by the cam follower arm 18, this movement is not constrained (at least initially) by the locking cylinder 40. The leaf spring is able to pivot upwards about a pivot 64 to the position shown in FIG. 5. The upwards movement of the distal end 64 does not therefore deform the leaf spring and so it does not exert a biasing force on the cam follower arm 18 or, in turn, the rotor 4. Accordingly, in this configuration, the biasing assembly 30 does not have a material effect on the rotation of the rotor.

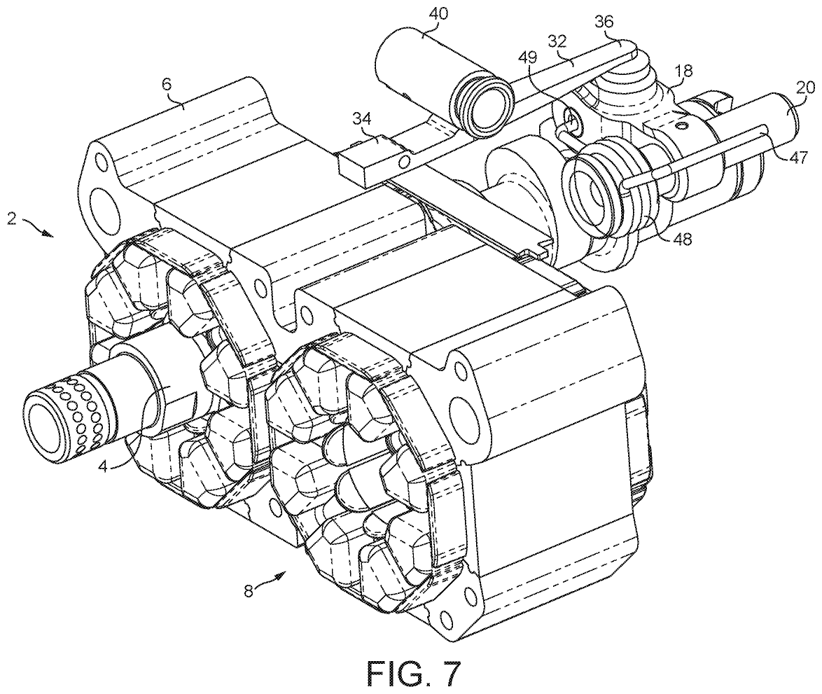

In a preferred configuration shown in FIG. 7, the cam follower arm 18 and leaf spring 32 are biased upwards by a coil spring 48. The spring may keep the cam follower arm, the leaf spring and the locking cylinder in contact with each other to avoid rattling of loose parts which may generate noise and wear of the parts. One end 47 of the spring may be held in a fixed position by engagement with a bearing housing (not shown in the Figures), whilst the other end 49 may be coupled to the distal end of the cam follower arm.

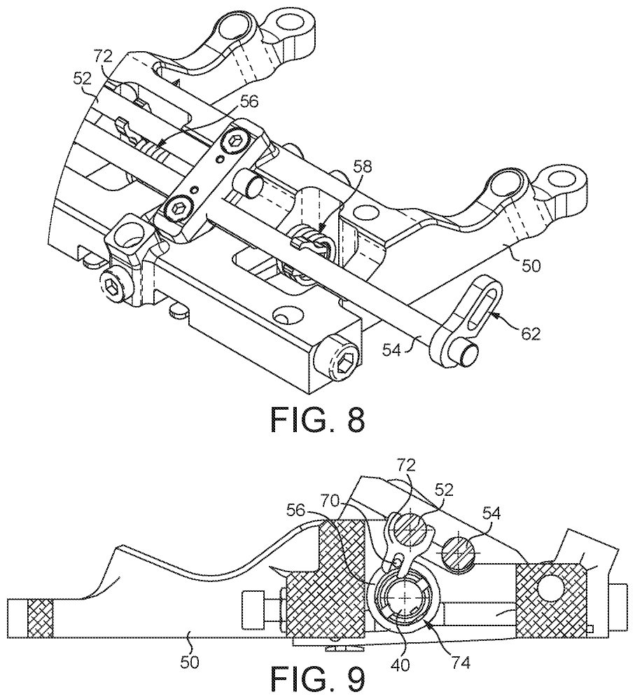

The configuration of the coupling present between each switching shaft 52,54 and the associated locking cylinders is more clearly visible in FIGS. 8 and 9. FIG. 9 shows a coupling associated with switching shaft 52. One end 70 of the torsion spring 56 is connected to an arm 72 mounted on switching shaft 52. The other end 74 of the torsion spring is located in a radial hole in the locking cylinder 40. In FIG. 9, switching shaft 52 is in its activated configuration. Clockwise rotation of the shaft when viewed in the direction shown in FIG. 9 has moved the arm 72, displacing the associated end 70 of the torsion spring 56, and causing the spring to exert a biasing force on the locking cylinder 40 which urges the cylinder to rotate in an anti-clockwise direction. This urges the locking cylinder towards the orientation shown in FIG. 3.

When the switching shaft is subsequently rotated anti-clockwise from the orientation shown in FIG. 9, this in turn displaces the associated end 70 of the torsion spring 56 so as to generate a biasing force urging the locking cylinder to rotate clockwise towards the configuration shown in FIG. 5.

When the distal end 36 of the leaf spring has been deflected upwards by the cam follower arm 18, it can be seen that the leaf spring may resist or block rotation of the locking cylinder from one orientation to another. Accordingly, the locking cylinder is not then able to immediately respond to switching of the switching shaft. However, the movement of the switching shaft is accommodated by deformation of the torsion spring 56 which stores mechanical strain energy in the torsion spring. As and when the leaf spring then moves downwards, the biasing force exerted to the locking cylinder by the torsion spring then rotates the locking cylinder into its other orientation.

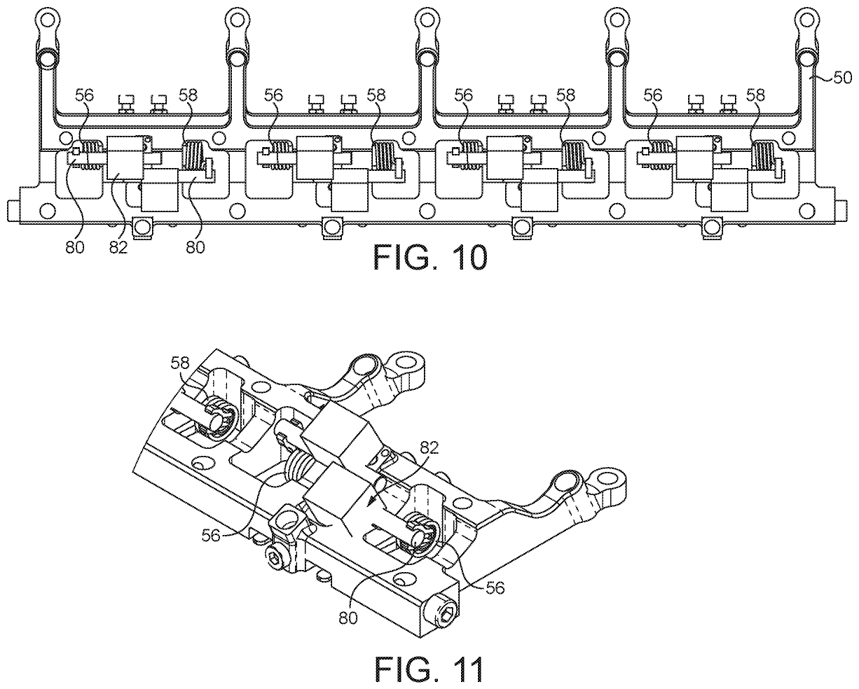

A modified embodiment of the configuration shown in FIG. 2 is illustrated in FIGS. 10 and 11. In this embodiment, each locking cylinder has its own switching shaft 80. Each switching shaft in turn has its own actuator 82 for selectively switching the respective shaft. In such a configuration, each biasing assembly can be switched from one configuration to another independently of the others to give greater flexibility of operation of multiple actuators.

1. An electromagnetic actuator comprising:
a stator;
a rotor which is rotatable relative to the stator over a range of rotation of the rotor; and
a biasing assembly for applying a torque to the rotor,
wherein the biasing assembly is switchable between:
(a) a first configuration in which the biasing assembly exerts a torque on the rotor over at least part of the range of rotation of the rotor, wherein the torque exerted varies with the rotational position of the rotor according to a torque profile; and
(b) a second configuration in which the biasing assembly exerts substantially no torque on the rotor over the range of rotation of the rotor.

2. The actuator of claim 1, wherein the biasing assembly is a mechanical assembly and comprises a resilient mechanical component.

3. The actuator of claim 2, wherein the biasing assembly comprises a constraining member, and, in the first configuration of the biasing assembly, the constraining member is in a first orientation and constrains movement of part of the resilient mechanical component and, in the second configuration, the constraining member is in a second orientation and does not constrain movement of the resilient component, as the rotor rotates over its range of rotation.

4. The actuator of claim 2, wherein the rotor defines a cam surface and the biasing assembly includes a cam follower in engagement with the cam surface, and the magnitude of the torque exerted on the rotor by the biasing assembly is dependent on the magnitude of the displacement of the cam follower by the cam surface.

5. The actuator of claim 4, wherein a first part of the resilient mechanical component forms or is coupled to the cam follower and moves in response to movement of the cam follower.

6. The actuator of claim 5, wherein a second part of the resilient mechanical component is more constrained in the first configuration of the biasing assembly than in the second configuration.

7. The actuator of claim 6, wherein the resilient mechanical component is a leaf spring which is pivotably mounted.

8. The actuator of claim 6, wherein the biasing assembly comprises a constraining member, and wherein movement of the second part of the resilient mechanical component is constrainable by reducing the distance between an engagement surface of the constraining member and the resilient mechanical component.

9. The actuator of claim 3, wherein the constraining member is a rotatable member which is rotated between its first orientation and its second orientation when the biasing assembly moves between its first configuration and its second configuration, respectively, wherein an engagement surface of the constraining member moves in a direction towards the resilient mechanical component when the rotatable member moves from its first orientation to its second orientation.

10. A control mechanism in combination with the actuator of claim 3, wherein the control mechanism comprises:
a controller which is moveable between first and second controller positions; and
a coupling between the controller and the biasing assembly,
wherein the coupling is arranged such that when the controller is in the first controller position, the coupling urges the constraining member towards its first orientation.

11. The combination of claim 10, wherein the controller is able to move from its second controller position to its first controller position even if the constraining member is not initially able to move into its first orientation.

12. The combination of claim 11, wherein the coupling comprises a resilient component which enables the controller to move from its second controller position to its first controller position even if the constraining member is not initially able to move into its first orientation.

13. The combination of claim 10, wherein the controller comprises a rotatable controller member which is rotatably mounted and/or the constraining member is rotatably mounted.

14. The combination of claim 12, wherein the resilient component is a torsion spring.

15. A control mechanism in combination with a plurality of actuators according to claim 3,
wherein the control mechanism comprises a controller which is moveable between first and second controller positions;
wherein the combination further includes a plurality of couplings, with each coupling provided between the controller and the biasing assembly of a respective one of the actuators; and
wherein each coupling is arranged such that when the controller is in the first controller position, the coupling urges the constraining member of the respective one of the actuators towards its first orientation.

16. An internal combustion engine including at least one cylinder having at least one valve and the actuator of claim 1, wherein the actuator is arranged to actuate the at least one valve.

17. An internal combustion engine of claim 16, including:
a plurality of cylinders each having at least one valve;
a plurality of actuators according to claim 3, wherein each of the actuators is arranged to actuate a respective valve;
a control mechanism, wherein the control mechanism comprises a controller which is moveable between first and second controller positions; and
a plurality of couplings, with each coupling provided between the controller and the biasing assembly of a respective one of the actuators, wherein the each coupling is arranged such that when the controller is in the first controller position, the coupling urges the constraining member of the respective one of the actuators towards its first orientation.

18. An internal combustion engine including:
a plurality of cylinders each having at least one valve;
a plurality of actuators according to claim 3, wherein each actuator is coupled to a respective valve of the plurality of valves;
a plurality of control mechanisms, wherein each control mechanism comprises a controller which is moveable between first and second controller positions, wherein each controller is moveable independently of the other controllers; and
a plurality of couplings, wherein each coupling is provided between a respective controller of the plurality of control mechanisms and the biasing assembly of a respective one of the plurality of actuators, and wherein each coupling is arranged such that when the respective controller is in its first controller position, the coupling urges the constraining member of the respective one of the actuators towards its first orientation.

19. An internal combustion engine, including:
a plurality of cylinders each having at least two valves, with one valve of each cylinder belonging to a first set of valves and a second valve of each cylinder belonging to a second set of valves;
a plurality of actuators according to claim 3, wherein the plurality of actuators comprises a first set of actuators arranged to actuate respective ones of the first set of valves and a second set of actuators arranged to actuate respective ones of the second set of valves;
first and second control mechanisms, each comprising a respective controller which is moveable between first and second controller positions, wherein the controller of each control mechanism is moveable independently of the other controller; and
first and second sets of couplings, with each coupling of the first set provided between the controller of the first control mechanism and the biasing assembly of a respective one of the first set of actuators and each coupling of the second set provided between the controller of the second control mechanism and the biasing assembly of a respective one of the second set of actuators, and wherein each coupling is arranged such that when the respective controller is in its first controller position, the coupling urges the constraining member of the respective one of the actuators towards its first orientation.

20. A method of operating an electromagnetic actuator comprising:
a stator;
a rotor which is rotatable relative to the stator over a range of rotation of the rotor; and
a biasing assembly for applying a torque to the rotor,
the method comprising the step of switching the biasing assembly between:
(a) a first configuration in which the biasing assembly exerts a torque on the rotor over at least part of the range of rotation of the rotor, wherein the torque exerted varies with the rotational position of the rotor according to a torque profile; and
(b) a second configuration in which the biasing assembly exerts substantially no torque on the rotor over the range of rotation of the rotor.

21. The method of claim 20, wherein the actuator is arranged to actuate a valve of a cylinder in an internal combustion engine.
